(19) United States
(12) Patent Application Publication
(10) Pub. No.: US 2026/0172244 A1
(43) Pub. Date: Jun. 18, 2026

(54) DATA PROCESSING APPARATUS, DATA PROCESSING METHOD, AND PROGRAM

(71) Applicant: Sony Semiconductor Solutions Corporation, Kanagawa (JP)

(72) Inventors: Kumiko Mahara, Kanagawa (JP); Akihiko Nagao, Kanagawa (JP)

(21) Appl. No.: 18/864,236

(22) PCT Filed: Jun. 2, 2023
(86) PCT No.: PCT/JP23/20594

§ 371 Date: Aug. 25, 2025

(30) Foreign Application Priority Data
Jun. 16, 2022 (JP) 2022-097032

(51) Int. Cl. H04L 9/08; H04L 9/06; H04N 23/661

(52) U.S. Cl. CPC H04L 9/088; H04L 9/0631; H04N 23/662

(57) ABSTRACT

Processing that automatically recognizes functions supported by an apparatus is disclosed. In one example, an imaging unit captures an image. A memory stores compatible function information regarding a supported function as a function when communicating with another apparatus in a read only region, and an output is configured to output the compatible function information to another connected apparatus. The technology can be applied, for example, to an image sensor and a host that controls the image sensor.

### DESCRIPTION

### Technical Field

The present technology relates to a data processing apparatus, a data processing method, and a program, and for example, relates to a data processing apparatus, a data processing method, and a program configured to notify another apparatus of functions supported by the data processing apparatus itself among a plurality of functions.

### Background Art

There is a technology for improving security regarding transmission of image data from a camera connected to a network (see, for example, Patent Documents 1 and 2). Meanwhile, some cameras are provided with a register that stores various setting information regarding imaging conditions and the like by the image sensor, various setting information regarding transmission of image data from the image sensor to the host inside the camera, and the like.

### CITATION LIST

### Patent Document

Patent Document 1: Japanese Patent Application Laid-Open No. 2019-33368
Patent Document 2: Japanese Unexamined Patent Application Publication No. 2018-525866

### SUMMARY OF THE INVENTION

### Problems to be Solved by the Invention

There is a plurality of authentication schemes, schemes for checking whether or not data is tampered, and the like between the image sensor and the host. The image sensor and the host need to be aware of each other, for example, by which scheme authentication is performed, whether data is checked, and the like.

The present technology has been made in view of such a situation, and enables notification of supported functions among a plurality of functions.

### Solutions to Problems

A first data processing apparatus according to one aspect of the present technology is a data processing apparatus including: an imaging unit that captures an image; a storage unit that stores compatible function information regarding a supported function as a function when communicating with another apparatus in a read only region; and an output unit that outputs the compatible function information stored in the storage unit to another apparatus connected.

A first data processing method according to one aspect of the present technology is a data processing method in which a data processing apparatus including an imaging unit that captures an image is configured to: store compatible function information regarding a supported function as a function when communicating with another apparatus in a read only region; and output the compatible function information stored to another apparatus connected.

A first program according to one aspect of the present technology is a program for causing a computer that controls a data processing apparatus including an imaging unit that captures an image to execute processing including steps of: storing compatible function information regarding a supported function as a function when communicating with another apparatus in a read only region; and outputting the compatible function information stored to another apparatus connected.

A second data processing apparatus according to one aspect of the present technology is a data processing apparatus including: a request unit that requests another apparatus including an imaging unit that captures an image to notify compatible function information regarding a supported function as a function when the another apparatus performs communication; a storage unit that stores the compatible function information notified from the another apparatus in response to the request; and a control unit that controls the communication with the another apparatus on the basis of the compatible function information stored in the storage unit.

A second data processing method according to one aspect of the present technology is a data processing method in which a data processing apparatus that processes data from another apparatus including an imaging unit that captures an image is configured to:
request the another apparatus to provide notification of compatible function information regarding a supported function as a function when the another apparatus communicates; store the compatible function information notified from the another apparatus in response to the request; and control the communication with the another apparatus on the basis of the stored compatible function information.

A second program according to one aspect of the present technology is a program for causing a computer that controls a data processing apparatus that processes data from another apparatus including an imaging unit that captures an image to execute processing including steps of: requesting the another apparatus to notify compatible function information regarding a supported function as a function when the another apparatus performs communication; storing the compatible function information notified from the another apparatus in response to the request; and controlling the communication with the another apparatus on the basis of the compatible function information stored.

In the first data processing apparatus, the data processing method, and the program according to one aspect of the present technology, compatible function information regarding a supported function as a function when communicating with another apparatus is stored in a read only region, and the compatible function information stored is output to another apparatus connected.

In the second data processing apparatus, the data processing method, and the program according to one aspect of the present technology, a request for notification of compatible function information regarding a supported function as a function when another apparatus performs communication is made to the another apparatus, the compatible function information notified from the another apparatus is written in response to the request, and the communication with the another apparatus is controlled on the basis of the compatible function information stored.

Note that the data processing apparatus may be an independent apparatus or an internal block constituting one apparatus.

Note that the program can be provided by being transmitted via a transmission medium or by being recorded on a recording medium.

### BRIEF DESCRIPTION OF DRAWINGS

FIG. 1 is a diagram for explaining a configuration example of a data transmission system.

FIG. 2 is a diagram for explaining another configuration example of the data transmission system.

FIG. 3 is a diagram for explaining a configuration example of a data transmission system.

FIG. 4 is a diagram for explaining a configuration example of a data transmission system.

FIG. 5 is a diagram for explaining a configuration example of a register.

FIG. 6 is a diagram illustrating an example of a format of compatible function information.

FIG. 7 is a diagram for explaining bit assignment regarding an authentication scheme.

FIG. 8 is a diagram for explaining function selection processing.

FIG. 9 is a diagram for explaining processing related to notification of compatible function information.

FIG. 10 is a diagram for explaining addition of compatible function information to data.

FIG. 11 is a diagram illustrating an example of different formats.

FIG. 12 is a diagram for explaining format conversion.

FIG. 13 is a diagram illustrating a configuration example of a PC.

### MODE FOR CARRYING OUT THE INVENTION

Modes for carrying out the present technology (hereinafter, referred to as embodiments) will be described below.

### System Configuration Example

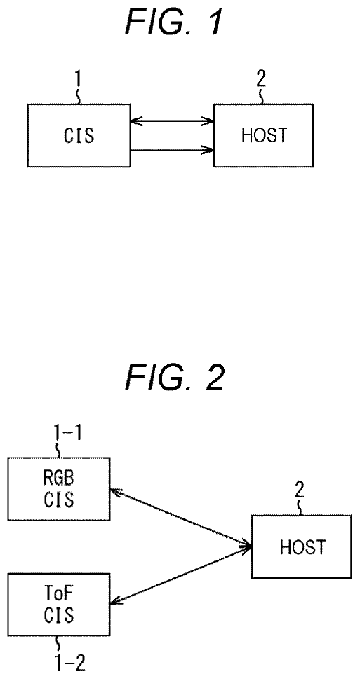

FIG. 1 is a diagram illustrating a configuration of an embodiment of a data transmission system to which the present technology is applied. The data transmission system according to an embodiment includes, for example, an image sensor (CIS (Complementary Metal-Oxide Semiconductor (CMOS) Image Sensor) 1) inside a camera and a host 2.

The CIS 1 and the host 2 may be on a one-to-one basis or on a multiple-to-one basis. For example, as in the data transmission system illustrated in FIG. 2, two of a CIS 1-1 and a CIS 1-2 may be connected to one host 2. The CIS 1 connected to the host 2 may be a CIS having different performance.

In the example illustrated in FIG. 2, the CIS 1-1 is an RGB (Red, Green, Blue) sensor, and is a sensor that captures a color image. Meanwhile, the CIS 1-2 is a time of flight (ToF) sensor, and is a sensor that captures an image for distance measurement.

In the following description, a case where one CIS 1 is connected to the host 2 will be described as an example. However, even in a case where a plurality of CISs 1 is connected to the host 2, the basic configuration and operation are similar to those in the case described below.

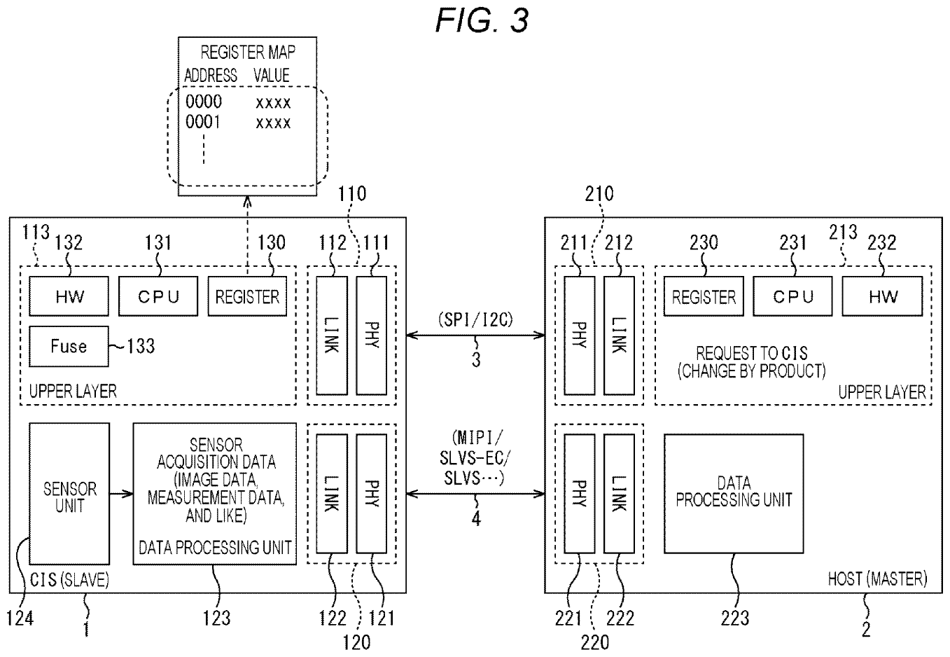

FIG. 3 is a diagram illustrating a more detailed configuration example of the data transmission system. The data transmission system illustrated in FIG. 3 includes a CIS 1 as a data processing apparatus, a host 2, a transmission path 3, and a transmission path 4.

The CIS 1 includes a communication unit 110, an upper layer 113, a communication unit 120, a data processing unit 123, and a sensor unit 124.

The communication unit 110 includes a physical layer (PHY) 111 and a link layer (LINK) 112. The communication unit 120 includes a physical layer (PHY) 121 and a link layer (LINK) 122.

The upper layer 113 includes a register 130, a central processing unit (CPU) 131, hardware (HW) 132, and a Fuse 133. Note that the CPU131 may be omitted as the upper layer 113.

The host 2 includes a communication unit 210, an upper layer 213, a communication unit 220, and a data processing unit 223.

The communication unit 210 includes a physical layer (PHY) 211 and a link layer (LINK) 212. The communication unit 220 includes a physical layer (PHY) 221 and a link layer (LINK) 222.

The upper layer 213 includes a register 230, a CPU 231, and hardware (HW) 232.

The CIS 1 includes a communication IF (register IF) that communicates with the CIS 1 as a slave and the host 2 as a master, and a high-speed IF (data output IF) that outputs large data such as image data acquired by the sensor unit 124.

Each of the communication unit 110 of the CIS 1 and the communication unit 110 of the host 2 constitutes a communication IF (register IF) capable of mutual communication (register communication) between the registers 130 and 230 via the transmission path 3. The register IF may be configured to be capable of switching a plurality of types of IFs by mounting a plurality of types of IFs having different protocols. For example, two types of IFs of a serial peripheral interface (SPI) and an inter integrated circuit (I2C) may be mounted and configured to be switchable.

The communication unit 120 of the CIS 1 constitutes a high-speed IF (data output IF) that outputs large data such as image data acquired from the sensor unit 124 to the communication unit 220 of the host 2 via the transmission path 4. The high-speed IF is an interface that can exchange data faster than register communication. Examples of the high-speed IF include mobile industry processor interface (MIPI), scalable low voltage signaling with embedded clock (SLVS-EC), and scalable low voltage signaling (SLVS).

The register 130 of the CIS 1 stores the setting information transmitted from the host 2 via the register IF. The processing operation of each unit inside the CIS 1 is determined depending on what value is set as the setting information in the register 130. Examples of the setting information include information such as exposure time, Gain, resolution (pixel addition and thinning number), frame rate, region of interest (ROI), and other operation modes.

The register 130 of the CIS 1 also stores information on various states, environmental information, and the like in the CIS 1. Information on various states, environmental information, and the like stored in the register 130 can be read from the host 2 via the register IF. Examples of the information of various states, environmental information, and the like include temperature information inside the CIS 1, metadata when the image information from the sensor unit 124 is processed by the data processing unit 123, and detection information of errors and warnings.

In the host 2, the upper layer 213 determines how to cause the CIS 1 to behave, and a value that determines the behavior of the CIS 1 is transmitted as setting information via the register IF. The host 2 changes the value of the setting information according to information of various states, environment information, and the like read from the register 130 of the CIS 1. Since the behavior of the CIS 1 varies depending on the use case, the software (SW) of the CPU 231 of the host 2 is often configured to be rewritable relatively easily. In a case where the upper layer 213 includes a field programmable gate array (FPGA), both the CPU 231 and the hardware 232 have a variable configuration.

By determining the standards or the like of the physical layers 111 and 211 and the link layers 112 and 212 constituting the register IF by making rules, communication between the CIS 1 and the host 2 can be performed regardless of products. The product-specific portion is only required to be determined only by the upper layers 113 and 213, for example, according to a specification (definition of an address and a value) of the registers 130 and 230 or the like.

For example, how to transmit the setting information in the register IF is defined as a rule in the specifications of the physical layers 111 and 211 and the link layers 112 and 212. As a result, the upper layers 113 and 213 can exchange control information and other information between the CIS 1 and the host 2 via the register IF only by defining the address of the registers 130 and 230, the operation in a case where a value is set in the register 130, and the like.

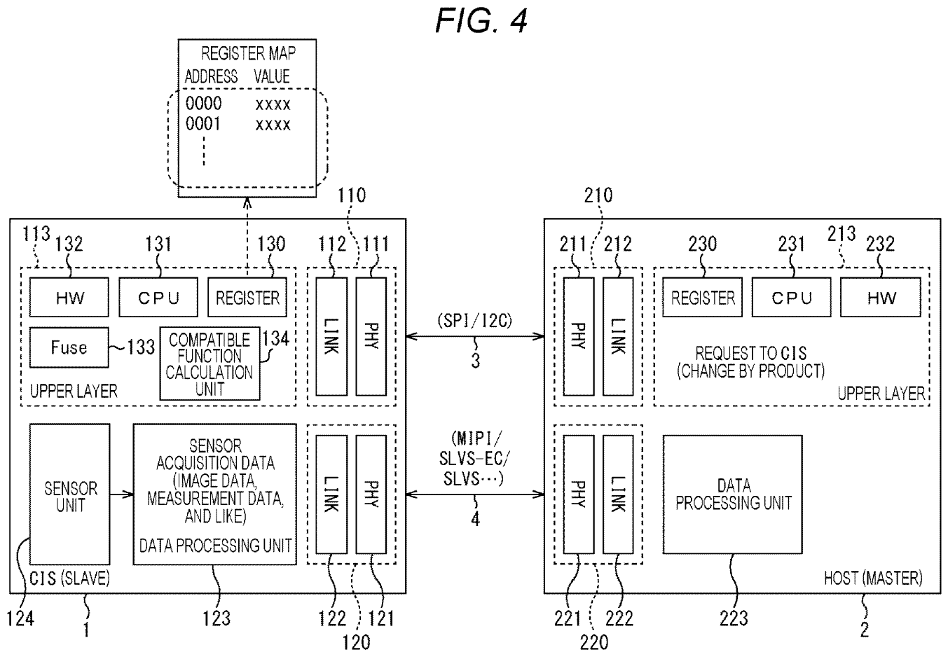

FIG. 4 is a diagram illustrating another configuration example of the data transmission system. The data transmission system illustrated in FIG. 4 is different from the data transmission system illustrated in FIG. 3 in that a compatible function calculation unit 134 is added to the CIS 1 of the data transmission system illustrated in FIG. 3, and the other points are similar.

The CIS 1 can be a CIS 1 supporting a plurality of functions. Supporting a plurality of functions includes, for example, a case where an authentication function supports a plurality of authentication schemes and a case where a functional safety function supports a plurality of functional safety. In addition, supporting a plurality of functions includes a case where a plurality of functions is supported such as having different functions such as an authentication function and an encryption function.

The CIS 1 includes a Fuse 133. By providing the Fuse 133, even in the CIS 1 that supports a plurality of functions, it is possible to customize to the CIS 1 that can selectively support a necessary function among the functions. For example, for each user who uses the CIS 1, customization such as supporting a function desired by the user but not supporting a function not desired by the user can be performed on the CIS 1.

For example, in the data transmission system illustrated in FIG. 2, the CIS 1-1 that captures RGB color images needs to maintain not only safety but also confidentiality in order to protect privacy of a subject, and can include a function of checking safety of data and a function of encrypting data, for example.

Meanwhile, since there is a low possibility that privacy of a subject is violated by the ToF image, the CIS 1-2 that captures the ToF image may not include a data encryption function for protecting privacy. In this case, the CIS 1-2 may have a function of checking the safety of data, but may not have an encryption function.

As described above, each CIS 1 can have a function suitable for the use situation of the CIS 1, and the selection of the function can be performed by the Fuse 133. In the above example, it is described that the Fuse 133 included in the CIS 1-1 supports the authentication function and the encryption function. It is described that the Fuse 133 included in the CIS 1-2 supports the authentication function but does not support the encryption function.

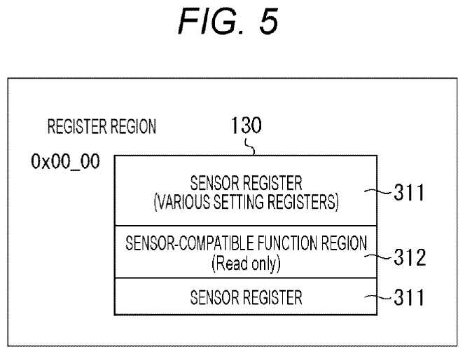

In the Fuse 133 of the CIS 1 illustrated in FIG. 3, a Fuse value corresponding to a mounted product (in this case, CIS 1), that is, information capable of uniquely identifying a supported function is written at the time of manufacturing. The information written in the Fuse 133 is written in a predetermined region (a sensor-compatible function region 312 described later with reference to FIG. 5) of the register 130, for example, at the time of activation of the CIS 1 or the like, and the written information can be referred to by the host 2. A region in which the function supported by the CIS 1 of the register 130 is written is a read only region.

The Fuse 133 can be configured to handle a format of a compatible function including a one time programmable (OTP). The sensor-compatible function region 312 (FIG. 5) of the register 130 is a read only region at the time of operation after activation, but may be a writable region before function selection at the time of manufacturing the CIS 1, and information on a supported function corresponding to the selected function may be written. In this case, instead of the calculation in the CIS 1, a read only value itself may be written in the Fuse 133 at the time of manufacturing, and may be written in the register 130 at the time of activation or the like.

Although a case is also conceivable where the Fuse 133 has a value that cannot be switched, writing in a format suitable for a product using the CIS 1 is possible. For example, even if the format is different between a product for an automatic guided vehicle (AGV), a product for a monitoring camera, and the like, a format suitable for each market can be selected at the time of manufacturing according to this scheme. In this case, as illustrated in FIG. 3, the compatible function calculation unit 134 (FIG. 4) can be omitted.

In the Fuse 133 of the CIS 1 illustrated in FIG. 4, for example, a Fuse value corresponding to a product to be mounted at the time of manufacturing is set. The Fuse 133 has only functions selectable in the CIS 1. Other than the selectable functions, the compatible function calculation unit 134 may have a fixed value.

Information is written in the corresponding region of the register 130 in a secure situation such as fixing of a Fuse value at the time of manufacturing or authentication at the time of activation. The CIS 1 determines a static setting information value in the CIS 1 according to the determined operation, and sets a value in a read only region of the register 130 that can be read by the host 2. Alternatively, when transmitting the image data obtained by the sensor unit 124, the CIS 1 outputs the image data by including the information in the EBD of the data. For a function not equipped with the CIS 1, a value may be fixed at the time of mounting (designing).

### Configuration Example of Register

FIG. 5 illustrates an example of a configuration (register map) of the register 130. Note that the address in the register map illustrated in FIG. 5 and the drawings subsequent to FIG. 5 is an example, and can be changed as appropriate.

The register 130 in the CIS 1 has a setting region (sensor register 311) for storing setting information transmitted from the host 2 as an address region. In addition to the sensor register 311, a sensor-compatible function region 312 that stores information regarding a supported function is further provided.

As the information stored in the sensor-compatible function region 312, there is an authentication scheme between the host 2 and the sensor (CIS 1). The sensor-compatible function region 312 also stores a functional safety compatible format of a communication interface (IF) in communication with the host 2 via the transmission path 3, an encryption (+message authentication code (MAC) ) scheme of security data of the communication IF, and a MAC scheme of the communication IF.

The sensor-compatible function region 312 also stores a functional safety compatible format of a high-speed IF (interface) that communicates large data such as image data with the host 2 via the transmission path 4, an encryption (+MAC) scheme of security data of the high-speed IF, and a MAC scheme of the high-speed IF.

Here, the MAC will be described as an example, but another safety security technology such as a cyclic redundancy code (CRC) may be used. Here, the description will be continued assuming that the above-described seven items of information are stored in the sensor-compatible function region 312, but at least one item of information among the seven items is stored in the sensor-compatible function region 312. Furthermore, the seven items are not descriptions indicating limitations, and items other than the seven items may also be provided, and information of the items may also be stored in the sensor-compatible function region 312.

In the sensor-compatible function region 312, an address and a size of a region for storing a MAC and encrypted data can also be stored. The MAC and the encrypted data themselves can be stored in the sensor-compatible function region 312 or can be stored in the sensor register 311.

The encrypted data can be specified to be encrypted up to an address, and in such a case, the encrypted data is stored in the sensor register 311 in the example illustrated in FIG. 5 other than the sensor-compatible function region 312. Alternatively, a region for storing the MAC and the encrypted data may be provided in the register 130 as a region other than the sensor register 311 and the sensor-compatible function region 312.

### Specific Information Stored in Sensor-Compatible Function Region

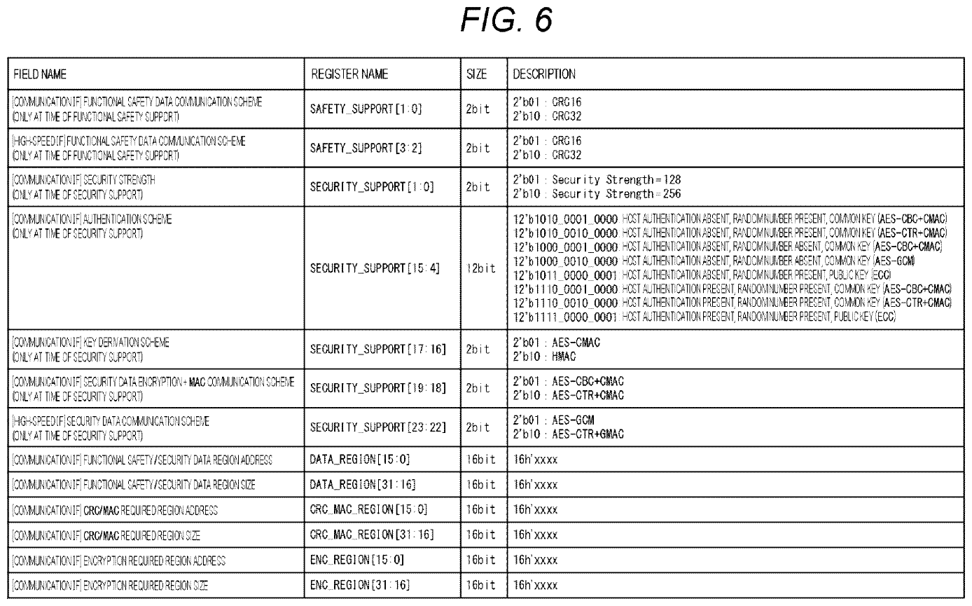

FIG. 6 illustrates an example of information (format) stored in the sensor-compatible function region 312.

The format illustrated in FIG. 6 is represented as a table with field names, register names, sizes, and descriptions associated.

In the field name “[communication IF] functional safety data communication scheme (only at the time of functional safety support)”, “SAFETY_SUPPORT [1:0]” as the register name, “2bit” as the size, and “2′b01: CRC16” and “2′b10: CRC32” as the description are associated. In this case, in the 2-bit region in which the address of the region in which the register name with SAFETY_SUPPORT of the sensor-compatible function region 312 of the register 130 is allocated is 0 to 1, information regarding the functional safety data communication scheme of the communication IF is described. In a case where the value is “01”, it indicates that the CRC16 is supported, and in a case where the value is “10”, it indicates that the CRC32 is supported.

In the field name “[high-speed IF] functional safety data communication scheme (only at the time of functional safety support)”, “SAFETY_SUPPORT [3:2]” as the register name, “2bit” as the size, and “2′b01: CRC16” and “2′b10: CRC32” as the description are associated. In this case, in the 2-bit region in which the address of the region in which the register name with SAFETY_SUPPORT of the sensor-compatible function region 312 of the register 130 is allocated is 2 to 3, information regarding the functional safety data communication scheme of the high-speed IF is described. In a case where the value is “01”, it indicates that the CRC16 is supported, and in a case where the value is “10”, it indicates that the CRC32 is supported.

In the field name “[communication IF] security strength (only at the time of security support) ”, “SECURITY_SUPPORT [1:0]” as the register name, “2bit” as the size, and “2′b01: Security Strength=128” and “2′b10: Security Strength=256” as the description are associated. In this case, in the 2-bit region in which the address of the region in which the register name with SECURITY SUPPORT of the sensor-compatible function region 312 of the register 130 is allocated is 0 to 1, information regarding the security strength of the communication IF is described. In a case where the value is “01”, it indicates that the 128 bits is supported, and in a case where the value is “10”, it indicates that the 256 bits is supported.

In the field name “[communication IF] authentication scheme (only at the time of security support) ”, “SECURITY_SUPPORT [15:4]” as the register name, “12bit” as the size, and “12′b1010_0001_0000: host authentication absent, random number present, common key (AES-CBC+CMAC)” as the description are associated. In addition, as the description, “12′b1010_0010_0000: host authentication absent, random number present, common key (AES-CTR+CMAC)”, “12′b1000_0001_0000: host authentication absent, random number absent, common key (AES-CBC+CMAC) ”, and “12′b1000_0010_0000: host authentication absent, random number absent, common key (AES-GCM) ”are also associated with“ [communication IF] authentication scheme (only at the time of security support)”.

Further, as the description, “12′b1011_0000_0001: host authentication absent, random number present, public key (ECC)”, “12′b1110_0001_0000: host authentication present, random number present, common key (AES-CBC+CMAC)”, “12′b1110_0010_0000: host authentication present, random number present, common key (AES-CTR+CMAC), and ”12′b1111_0000_0001: host authentication present, random number present, public key (ECC) are also associated with “[communication IF] authentication scheme (only at the time of security support)”.

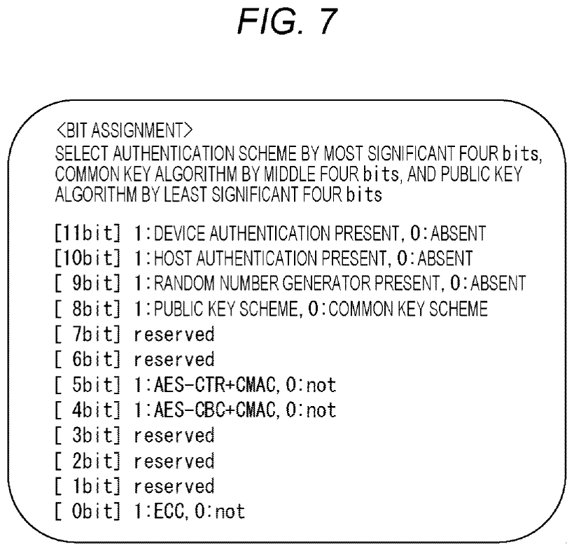

The bit assignment illustrated in FIG. 7 is allocated to each bit of 12 bits which is described in the description field of the field name “[communication IF] authentication scheme (only at the time of security support)”. Referring to FIG. 7, the most significant four bits define an authentication scheme, the middle four bits define an algorithm of a common key, and the least significant four bits define an algorithm of a public key.

In a case where [11bit] in the 12 bits is “1”, it indicates that device authentication is present, and in a case where it is “0”, it indicates that device authentication is absent. In a case where [10bit] in the 12 bits is “1”, it indicates that host authentication is present, and in a case where it is “0”, it indicates that host authentication is absent. In a case where [9bit] in 12 bits is “1”, it indicates that random number generator is present, and in a case where it is “0”, it indicates that random number generator is absent. In a case where [8bit] in 12 bits is “1”, it indicates the public key scheme, and in a case where it is “0”, it indicates the common key scheme.

[7bit] and [6bit] in the 12 bits are set as “reserved”. In a case where [5bit] in 12 bits is “1”, it indicates AES-CTR+CMAC, and in a case where “0”, it indicates not AES-CTR+CMAC. In a case where [4bit] in 12 bits is “1”, it indicates AES-CBC+CMAC, and in a case where “0”, it indicates not AES-CBC+CMAC.

[3bit], [2bit], and [1bit] in the 12 bits are set as “reserved”. In a case where [0bit] in the 12 bits is “1”, it indicates ECC, and in a case where it is “0”, it indicates not ECC.

Returning to the format illustrated in FIG. 6, in the field name “[communication IF] key derivation scheme (only at the time of security support)”, “SECURITY_SUPPORT [17:16]” as the register name, “2bit” as the size, and “2′b01: AES-CMAC” and “2′b10: HMAC” as the description are associated. In this case, in the 2-bit region in which the address of the region in which the register name with SECURITY_SUPPORT of the sensor-compatible function region 312 of the register 130 is allocated is 16 to 17, information regarding the key derivation scheme of the communication IF is described.

In a case where the value is “01”, it indicates that the AES-CMAC is supported as the key derivation scheme, and in a case where the value is “10”, it indicates that the HMAC is supported as the key derivation scheme.

In the field name “[communication IF] security data encryption +MAC communication scheme (only at the time of security support) ”, “SECURITY_SUPPORT [19:18]” as the register name, “2bit” as the size, and “2′b01: AES-CBC+CMAC” and “2′b10: AES-CTR+CMAC” as the description are associated. In this case, in the 2-bit region in which the address of the region in which the register name with SECURITY_SUPPORT of the sensor-compatible function region 312 of the register 130 is allocated is 18 to 19, information regarding the encryption of the security data of the communication IF and the communication scheme of the MAC is described. In a case where the value is “01”, it indicates that the AES-CBC+CMAC is supported as the combination of the encryption and the MAC, and in a case where the value is “10”, it indicates that the AES-CTR+CMAC is supported as the combination of the encryption and the MAC.

In the field name “[communication IF] functional safety/security data region address”, “DATA_REGION [15:0]” as the register name, “16bit” as the size, and “16h′xxxx” as the description are associated. In this case, it is indicated that information of an address in which data for functional safety and security is stored is described in a 16 bit region in which the address of the region to which the register name of DATA_REGION of the sensor-compatible function region 312 of the register 130 is allocated is 0 to 15.

In the field name “[communication IF] functional safety/security data region size”, “DATA_REGION [31:16]” as the register name, “16bit” as the size, and “16h′xxxx” as the description are associated. In this case, it is indicated that information regarding the size of data for functional safety and security is described in a 16 bit region in which the address of the region to which the register name of DATA_REGION of the sensor-compatible function region 312 of the register 130 is allocated is 16 to 31.

In the field name “[communication IF] CRC/MAC required region address”, “CRC_MAC_REGION [15:0]” as the register name, “16bit” as the size, and “16h′xxxx” as the description are associated. In this case, it is indicated that information of an address in which the CRC or MAC data is stored is described in a 16 bit region in which the address of the region to which the register name of CRC_MAC_REGION of the sensor-compatible function region 312 of the register 130 is allocated is 0 to 15.

In the field name “[communication IF] CRC/MAC required region size”, “CRC_MAC_REGION [31:16]” as the register name, “16bit” as the size, and “16h′xxxx” as the description are associated. In this case, it is indicated that information regarding the size of the CRC or MAC data is described in a 16 bit region in which the address of the region to which the register name of CRC MAC_REGION of the sensor-compatible function region 312 of the register 130 is allocated is 16 to 31.

In the field name “[communication IF] encryption required region address”, “ENC_REGION [15:0 ]” as the register name, “16bit” as the size, and “16h′xxxx” as the description are associated. In this case, it is indicated that information of an address in which the encrypted data is stored is described in a 16 bit region in which the address of the region to which the register name of ENC_REGION of the sensor-compatible function region 312 of the register 130 is allocated is 0 to 15.

In the field name “[communication IF] encryption required region size”, “ENC_REGION [31:16]” as the register name, “16bit” as the size, and “16h′xxxx” as the description are associated. In this case, it is indicated that information regarding the size of the encrypted data is described in a 16 bit region in which the address of the region to which the register name of ENC_REGION of the sensor-compatible function region 312 of the register 130 is allocated is 16 to 31.

Here, the description will be continued on the assumption that information in the format as illustrated in FIG. 6 is stored as the information stored in the sensor-compatible function region 312 of the register 130, but this is an example and is not a description indicating limitation. The information content to be written can be changed as appropriate.

By defining the format in this manner and writing the functions supported by the CIS 1 to the register 130 on the basis of the format, in a case where the CIS 1 supports a plurality of functions, the supported functions can be clearly expressed. The host 2 can recognize the functions supported by the CIS 1 by referring to the information described in this format.

For example, in the format example illustrated in FIG. 6, in the CIS 1 having all the functions of the eight authentication schemes described in the register name “SECURITY_SUPPORT [15:4]”, the authentication scheme required by the user who uses the CIS 1 or the authentication scheme required by the host 2 side can be selected and set as the function supported by the CIS 1. For example, in a case where host authentication absent, random number present, and public key (AES-CBC+CMAC) is a desired authentication scheme, information of “1010_0001_0000” is written in a region whose register name is “SECURITY_SUPPORT [15:4]”, so that it can be set that the authentication scheme supported by the CIS 1 is host authentication absent, random number present, and public key (AES-CBC+CMAC).

For example, at the time of manufacturing the CIS 1, it is possible to manufacture the CIS 1 supporting eight authentication schemes, then select a required authentication scheme according to a situation in which the CIS 1 is used, a request of a user of the CIS 1 or the host 2, or the like, and set the authentication scheme to be executed by the CIS 1. Even if CISs 1 in a same package is manufactured, since the CISs 1 can be customized individually thereafter, the manufacturing cost of the CISs 1 can be reduced.

On the basis of the format as illustrated in FIG. 6, information regarding the function supported by the CIS 1 is described in the sensor-compatible function region 312 of the register 130. When the power supply of the CIS 1 is turned on or the like, for example, information (function setting information) regarding the function supported by the CIS 1 is written in the sensor-compatible function region 312 of the register 130 by the Fuse 133 (FIGS. 3 and 4).

In the Fuse 133, data in which information can be written is described in the sensor-compatible function region 312 of the register 130 in the format as illustrated in FIG. 6. The data may be the same data as the data to be written in the sensor-compatible function region 312, or may be the same data as the data to be written in the sensor-compatible function region 312 by calculation by the compatible function calculation unit 134.

### Function Selection Processing

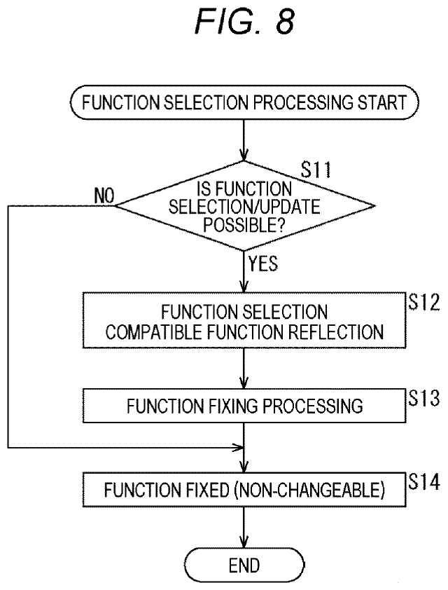

In the Fuse 133, for example, information regarding functions (required of the CIS 1) to be supported by the CIS 1 at the time of manufacturing or activation, here, information referred to as compatible function information is described. Here, processing when the compatible function information is written in the sensor-compatible function region 312 of the Fuse 133 or the register 130 will be described with reference to the flowchart of FIG. 8. Since this process is a process of selecting and setting desired functions from among a plurality of functions included in the CIS 1, it will be described as function selection processing here.

The function selection processing is performed when the CIS 1 is manufactured or/and when the CIS 1 is activated. First, a case where a function is selected and set when the CIS 1 is manufactured will be described.

In step S11, it is determined whether or not a function can be selected and updated. In a case where the Fuse 133 does not describe information on the function required for the CIS 1, it is determined in step S11 that the function can be selected and updated, and the processing proceeds to step S12.

In step S11, when it is determined that the function cannot be selected or updated is, for example, when information regarding the selected function is already described in the Fuse 133 or the like. In step S12, in a case where it is determined that the function cannot be selected or updated, the processing proceeds to step S14, and the function is fixed and set in a non-changeable state. This state is a state of the CIS 1 at the time of shipment.

In step S12, processing related to function selection and compatible function reflection is executed. In step S13, function fixing processing is executed. The processing of steps S12 and S13 is processing of setting and fixing a function requested to the CIS 1 in the Fuse 133. The function supported by the CIS 1 to be set is a function that the manufacturer wants the CIS 1 to have, and is set, for example, on the basis of a use environment of the CIS 1 or a request from a user. After the setting, the Fuse 133 is turned off, and the function cannot be updated.

In step S14, the set function is fixed, and the non-changeable state is maintained.

When the selected function is set and fixed in the Fuse 133, the CIS 1 is shipped, and when the power supply of the CIS 1 is turned on again, information regarding the function supported by the CIS 1 reflecting the function selected, set, and fixed at the time of manufacturing is written in the sensor-compatible function region 312 of the register 130 by the processing of the Fuse 133. The processing at this time can be performed, for example, on the basis of the flowchart illustrated in FIG. 8.

In a case where the power supply of the CIS 1 is turned on, it is determined in step S11 whether or not the function can be selected and updated, and it is determined that the function can be selected and updated.

In step S12, on the basis of the information set to the Fuse 133, information (compatible function information) regarding the supported function based on the format as described with reference to FIG. 6 is generated. In the case of the configuration of the CIS 1 as illustrated in FIG. 3, the Fuse 133 generates compatible function information based on the format as illustrated in FIG. 6 to be written in the sensor-compatible function region 312 of the register 130, and writes the compatible function information in the sensor-compatible function region 312.

In the case of the configuration of the CIS 1 as illustrated in FIG. 4, in response to an instruction from the Fuse 133, the compatible function calculation unit 134 generates compatible function information based on the format as illustrated in FIG. 6 to be written in the sensor-compatible function region 312 of the register 130, and writes the compatible function information in the sensor-compatible function region 312.

In step S13, after the compatible function information is written in the sensor-compatible function region 312 of the register 130 as the function fixing processing, the compatible function information written in the sensor-compatible function region 312 is set to the non-updateable state by the management of the status of the register 130.

By performing such processing, when the compatible function information written in the sensor-compatible function region 312 of the register 130 is set to the non-changeable state, the operation transitions to the normal operation (step S14).

Note that the authentication processing is executed between the CIS 1 and the host 2 at a time point before the CIS 1 is activated and information is written in the sensor-compatible function region 312 of the register 130, and the function selection processing illustrated in FIG. 8 is executed only in a case where the authentication is normally performed. That is, the function selection processing is executed only in a case where the secure state is secured. For example, in a case where the authentication processing is not normally executed, it is determined in step S11 that the update is impossible in the determination of whether the function can be selected and updated, and the subsequent processes are not executed.

The flowchart of the function selection processing illustrated in FIG. 8 can also be applied to, for example, a case where the host 2 selects a function from among a plurality of functions included in the CIS 1 and the selected function is set at the time of activation of the CIS 1.

In step S11, the result of the authentication processing is used to determine whether the function can be selected and updated, and when it is determined that the function can be selected and updated, the processing proceeds to step S12.

In step S12, function selection and compatible function reflection processing are executed. For the selection of the function, for example, the host 2 side notifies the CIS 1 of the function to be requested, and the Fuse 133 or the compatible function calculation unit 134 selects the function in response to an instruction from the Fuse 133 on the basis of the notification, and generates compatible function information reflecting the function requested to the CIS 1. In step S13, the compatible function information is described and fixed in the sensor-compatible function region 312 of the register 130 (set to a non-changeable state).

In this manner, the function of the CIS 1 can be selected and set in response to a request from the host 2 side.

Note that, in a case where the compatible function information is written in the sensor-compatible function region 312 of the register 130 at the time of activation, the authentication processing is performed between the CIS 1 and the host 2 in order to perform writing in a secure state, but what authentication scheme is applied to this authentication processing is set in advance between the CIS 1 and the host 2, and the authentication processing is executed by applying the set authentication scheme.

In a case where a function is selected in response to a request from the host 2 side at the time of activation of the CIS 1, for example, a user using the CIS 1 and the host 2, in other words, a user using the data transmission system illustrated in FIG. 3 or FIG. 4 can reflect a desired function. Therefore, even after the data transmission system is manufactured, it can be customized to the function desired by the user for each user.

### Processing on Host Side

In this manner, when the compatible function information regarding the function supported, selected, and set by the CIS 1 is written in the register 130 of the CIS 1, the compatible function information is provided to the host 2 when there is a request from the host 2 side. The host 2 side can communicate with the CIS 1 using the function supported by the CIS 1 by recognizing the function supported by the CIS 1.

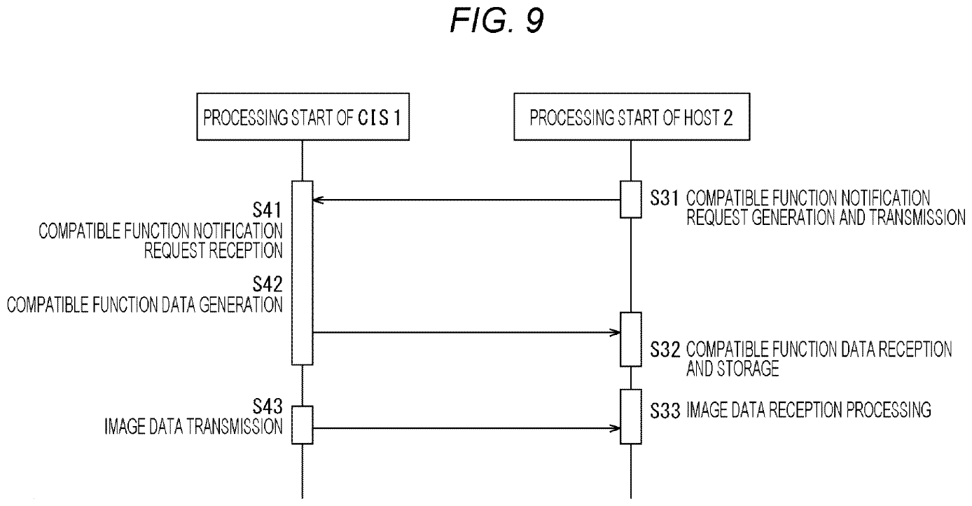

A process in a case where the host 2 acquires the compatible function information described in the register 130 of the CIS 1 will be described with reference to the flowchart of FIG. 9.

In step S31, the host 2 generates a request for notification of the compatible function to the CIS 1 and transmits the request to the CIS 1. In step S41, the CIS 1 receives the compatible function notification request. In step S42, in response to the request, the CIS 1 reads the compatible function information written in the sensor-compatible function region 312 of the register 130, generates data regarding the compatible function information, and outputs the data to the host 2.

In step S32, the host 2 receives the compatible function data from the CIS 1 and writes the compatible function information generated from the compatible function data to the register 230 (FIGS. 3 and 4). The host 2 can recognize a function supported by the CIS 1 by acquiring the compatible function information, and exchanges data with the CIS 1 by applying the recognized function, for example, an authentication scheme, an encryption scheme, or the like. The CIS 1 and the host 2 transition to the normal operation and start the normal operation.

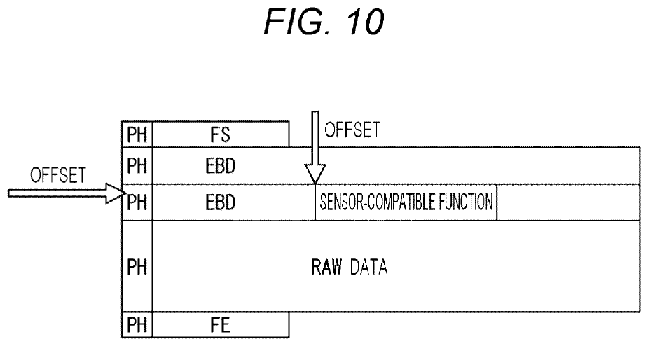

In step S43, the CIS 1 outputs image data captured by the sensor unit 124 to the host 2. FIG. 10 is a diagram illustrating image data (a frame format of one frame) transmitted from the CIS 1 to the host 2.

A Frame Start (FS) line and a Frame End (FE) line are arranged at the head and the end of the frame format, respectively. The Frame Start line is a line of data in which a value of 1 is set to Frame Start of the packet header. Furthermore, the Frame End line is a line of data in which a value of 1 is set to Frame End of the packet header.

Embedded Data (EBD) is arranged in the next two lines of the FS line, and image data (RAW data) for one frame, which is data of a plurality of lines, is arranged after the line in which the EBD is arranged. A packet header (PH) added to data of each line is illustrated at a left end of each line in FIG. 10.

Information on the sensor compatible function, in this case, all or a part of the compatible function information is arranged at a predetermined position of the line on which the EBD is arranged. The information of the sensor compatible function is described in a predetermined size from a predetermined position defined by the offset. The host 2 can recognize the function supported by the CIS 1 by referring to the information described in the region defined by the offset.

The information of the sensor-compatible function described at the predetermined position of the line on which the EBD is arranged may be all information described in the sensor-compatible function region 312 of the register 130 in the format illustrated in FIG. 6, or may be a part of information. In the case of a part of the information, for example, information regarding the high-speed IF in which image data is exchanged, such as a functional safety compatible format of the high-speed IF, an encryption scheme of security data of the high-speed IF, and a MAC scheme of the high-speed IF, can be described.

For example, as described with reference to FIG. 2, in the data transmission system in which the host 2 and a plurality of CISs 1 exchange data, as described with reference to FIG. 10, when image data (RAW data) is transmitted, the host 2 side can easily determine from which CIS 1 the data is from by including information regarding a function supported by the CIS 1 in the data.

When the data transmission system illustrated in FIG. 2 is described as an example, the compatible function information included in the image data transmitted from the CIS 1-1 is different from the compatible function information included in the image data transmitted from the CIS 1-2. The host 2 can determine whether the data is from the CIS 1-1 or the CIS 1-2 by referring to the compatible function information included in the received data. In addition, it is possible to execute processing of the received data on the basis of the compatible function information included in the received data, for example, processing of executing decryption processing or the like on the basis of the information regarding the encryption scheme included in the compatible function information.

By performing the processing of the flowchart illustrated in FIG. 9 for each connected CIS 1, the host 2 acquires compatible function information regarding the function supported by the CIS 1 for each CIS 1, and stores the compatible function information in the register 230. In a case of receiving data from the CIS 1, the host 2 can confirm whether or not the CIS 1 is performing a desired operation by comparing the compatible function information included in the received data with the compatible function information stored in the register 230.

For example, in a case where the compatible function information included in the received data is different from the compatible function information stored in the register 230, it can be determined that the CIS 1 is not performing a desired operation. Furthermore, in such a case, it is also possible to perform simple determination that there is a possibility that the CIS 1 has sent invalid data.

It is also possible to check whether or not there is a change in the compatible function information included in the data from the CIS 1 and to determine that the CIS 1 is not performing a desired operation in a case where the compatible function information has been changed without an instruction from the host 2.

In a case where the CIS 1 of a different format is connected to the host 2, the host 2 acquires and stores the compatible function information of the different format.

For example, in the data transmission system illustrated in FIG. 2, a case where the CIS 1-1 is a sensor that captures a color image, and the CIS 1-2 is a sensor that captures a ToF image, and transmits compatible function information in different formats will be described as an example.

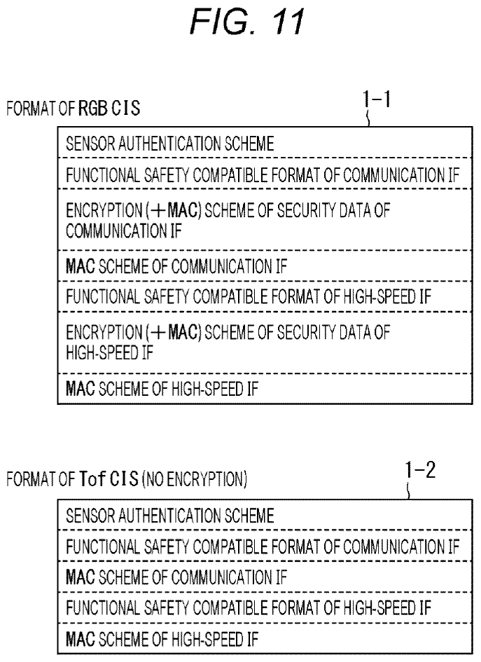

FIG. 11 illustrates a format of the compatible function information of the CIS 1-1 and a format of the compatible function information of the CIS 1-2. Referring to the format of the CIS 1-1 illustrated in the upper part of FIG. 1, the format of the CIS 1-1 describes seven items of information including a sensor authentication scheme, a functional safety compatible format of a communication IF, an encryption (+MAC) scheme of security data of the communication IF, a MAC scheme of the communication IF, a functional safety compatible format of a high-speed IF, an encryption (+MAC) scheme of security data of the high-speed IF, and a MAC scheme of the high-speed IF.

Referring to the format of the CIS 1-2 illustrated in the lower part of FIG. 1, the format of the CIS 1-2 describes five items of information including a sensor authentication scheme, a functional safety compatible format of a communication IF, a MAC scheme of a communication IF, a functional safety compatible format of a high-speed IF, and a MAC scheme of a high-speed IF. In this case, since the CIS 1-2 is not required to have an encryption function as a function, the format of the CIS 1-2 does not describe information related to encryption, in this example, information related to the two items of the encryption (+MAC) scheme of the security data of the communication IF and the encryption (+MAC) scheme of the security data of the high-speed IF.

The compatible function information may be managed in such different formats by the CIS 1 or the host 2, but conversion conforming to one format may be performed, and the compatible function information may be managed in the same format. In a case where there is a difference in format as illustrated in FIG. 11, the format of the CIS 1-2 having a smaller number of items of information is converted, and conversion is performed to match the format of the CIS 1-1 having a larger number of items of information.

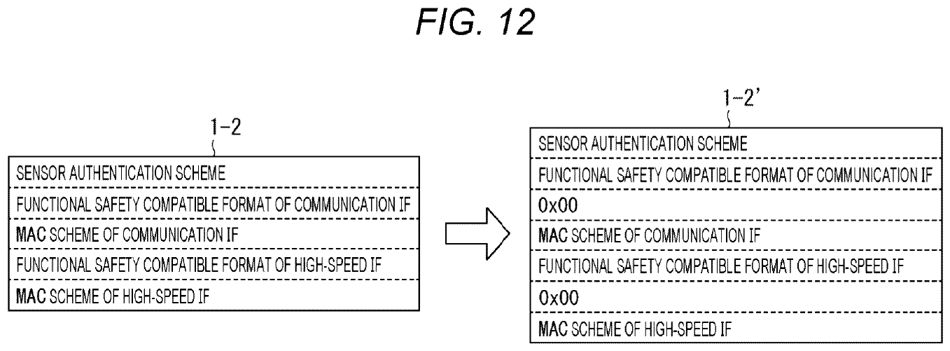

Format conversion will be described with reference to FIG. 12. Similarly to the lower diagram illustrated in FIG. 11, the left diagram of FIG. 12 illustrates the compatible function information (referred to as compatible function information 1-2) in the format before conversion of the CIS 1-2, and the right diagram illustrates the compatible function information (referred to as compatible function information 1-2′) in the format after the change.

Referring to the right diagram in FIG. 12 illustrating the compatible function information 1-2′in the format after the conversion, information indicating not supported, for example, information such as “Ox00” is described in a region in which the information regarding the encryption (+MAC) scheme of the security data of the communication IF is described and a region in which the information regarding the encryption (+MAC) scheme of the security data of the high-speed IF is described.

In the format after conversion, seven items of information are described as in the format of the CIS 1-1 illustrated in the upper part of FIG. 11. As described above, the format conversion may be performed such that the number of items in a format having a small number of items becomes the same as the number of items in other formats, and the compatible function information after the format conversion may be managed.

Such format conversion may be performed on the CIS 1 side so that the compatible function information in the format after conversion is provided to the host 2, or may be performed on the host 2 side so that the format conversion is performed in a case where the compatible function information in the format before conversion is provided from the CIS 1.

In a case where the format conversion is performed on the CIS 1 side, the write region of the Fuse 133 may be configured to be able to be specified larger than the region in a case where writing is performed in an assumed format, and the compatible function information in the above-described format after conversion can be written.

As described above, the sensor (CIS 1) includes a register (the sensor-compatible function region 312 of the register 130) that is readable (not writable) when the sensor is used and indicates in what functional safety/security mode the communication IF or the high-speed IF of the sensor operates. By reading the information in this region, another device connected to the sensor such as the host 2 can be configured to identify the function supported by the sensor.

By applying the above-described format, the address of the register can be specified by the product only for the offset, and the size/address relationship of the registers from the head register to the subsequent registers can be made common or compatible between the market, the standard, the system in which the sensor is mounted, and the like.

In a case where data is output from the sensor (CIS 1) to the host 2 side, it is also possible to configure such that information of the high-speed IF is inserted into the EBD or the like of the data and is output together with the data. Also in the case of the output by the EBD, the output start position can be specified, and the subsequent formats can be made common or compatible between the market, the standard, the system in which the sensor is mounted, and the like. By outputting the information together with the image data, it is possible to check whether the host 2 is performing an expected operation and to check the identity of the data.

In a case where a plurality of functions can be implemented on the sensor and can be selected, the register may be provided with a mechanism capable of selecting a function at the time of manufacturing and updating the function by the Fuse 133 or the like.

The mode of normal communication and data output can be updated only in a case where a secure state such as at the time of authentication at the time of activation is guaranteed, whereby it is possible to prevent the supported function from being rewritten by an attack from a malicious apparatus.

### Recording Medium

The above-described series of processing can be executed by hardware or software. In a case where the series of processing is executed by software, a program constituting the software is installed in a computer. Here, the computer includes a computer incorporated in dedicated hardware, a general-purpose personal computer capable of executing various functions by installing various programs, and the like, for example.

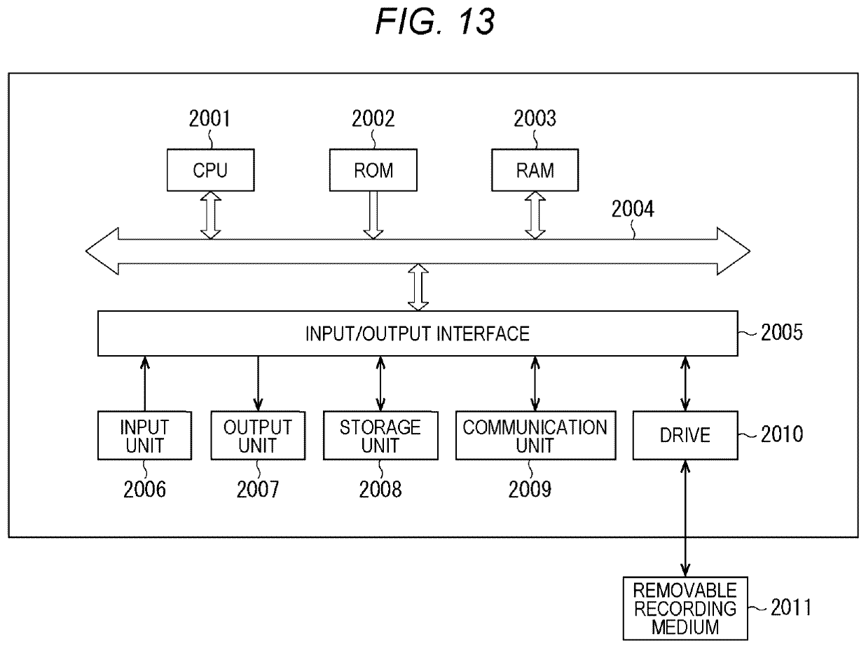

FIG. 13 is a block diagram illustrating a configuration example of hardware of a computer that executes the above-described series of processing by a program. In the computer, a central processing unit (CPU) 2001, a read only memory (ROM) 2002, and a random access memory (RAM) 2003 are mutually connected by a bus 2004. An input/output interface 2005 is further connected to the bus 2004. An input unit 2006, an output unit 2007, a storage unit 2008, a communication unit 2009, and a drive 2010 are connected to the input/output interface 2005.

The input unit 2006 includes a keyboard, a mouse, a microphone, and the like. The output unit 2007 includes a display, a speaker, and the like. The storage unit 2008 includes a hard disk, a nonvolatile memory, and the like. The communication unit 2009 includes a network interface and the like. The drive 2010 drives a removable medium 2011 such as a magnetic disk, an optical disk, a magneto-optical disk, or a semiconductor memory.

In the computer configured as described above, for example, the CPU 2001 loads a program stored in the storage unit 2008 into the RAM 2003 via the input/output interface 2005 and the bus 2004 and executes the program, whereby the above-described series of processing is performed.

The program executed by the computer (CPU 2001) can be provided by being recorded in the removable medium 2011 as a package medium or the like, for example. Furthermore, the program can be provided via a wired or wireless transmission medium such as a local area network, the Internet, or digital satellite broadcasting.

In the computer, the program can be installed in the storage unit 2008 via the input/output interface 2005 by attaching the removable medium 2011 to the drive 2010. Furthermore, the program can be received by the communication unit 2009 via a wired or wireless transmission medium and installed in the storage unit 2008. In addition, the program can be installed in the ROM 2002 or the storage unit 2008 in advance.

Note that the program executed by the computer may be a program in which processing is performed in time series in the order described in the present specification, or may be a program in which processing is performed in parallel or at necessary timing such as when a call is made.

In the present specification, the system represents the entire apparatus including a plurality of apparatuses.

Note that the effects described in the present specification are merely examples and are not limited, and other effects may be provided.

Note that the embodiments of the present technology are not limited to the above-described embodiments, and various modifications can be made without departing from the gist of the present technology.

Note that the present technology can also have the following configurations.

(1)

A data processing apparatus including:
an imaging unit that captures an image;
a storage unit that stores compatible function information regarding a supported function as a function when communicating with another apparatus in a read only region; and
an output unit that outputs the compatible function information stored in the storage unit to another apparatus connected.
   (2)

The data processing apparatus according to (1),
in which the storage unit is a register, and a partial region of the register is the read only region.
   (3)

The data processing apparatus according to (2), further including:
an interface for register communication that exchanges data to be stored or stored in the register with the another apparatus; and
an interface for high-speed communication that performs communication at a higher speed than the register communication for exchanging image data of the image captured by the imaging unit.
   (4)

The data processing apparatus according to (3),
in which the compatible function information includes at least one or more pieces of information regarding an authentication scheme with the another apparatus, a functional safety compatible format of the register communication, an encryption scheme of security data of the register communication, an encryption scheme of the register communication, a functional safety compatible format of the high-speed communication, an encryption scheme of security data of the high-speed communication, or an encryption scheme of the high-speed communication.
   (5)

The data processing apparatus according to any one of (1) to (4), further including
a Fuse,
in which the compatible function information regarding a selectable function is written in the Fuse.
   (6)

The data processing apparatus according to any one of (1) to (4), further including:
a Fuse; and
a generation unit that generates the compatible function information stored in the storage unit by using information stored in the Fuse.
   (7)

The data processing apparatus according to any one of (1) to (6),
in which when image data captured by the imaging unit is output to the another apparatus, part or all of the compatible function information is added to the image data and output.
   (8)

The data processing apparatus according to any one of (1) to (7),
in which information is described in the compatible function information on the basis of a predetermined format, and
in a case where there is a function that is not supported, information corresponding to the function is converted into the compatible function information based on the format by inserting information indicating that the function is not supported, and then output to the another apparatus.
   (9)

A data processing method in which a data processing apparatus including an imaging unit that captures an image is configured to:
store compatible function information regarding a supported function as a function when communicating with another apparatus in a read only region; and
output the compatible function information stored to another apparatus connected.
   (10)

A program for causing a computer that controls a data processing apparatus including an imaging unit that captures an image to execute processing including steps of:
storing compatible function information regarding a supported function as a function when communicating with another apparatus in a read only region; and
outputting the compatible function information stored to another apparatus connected.
   (11)

A data processing apparatus including:
a request unit that requests another apparatus including an imaging unit that captures an image to notify compatible function information regarding a supported function as a function when the another apparatus performs communication;
a storage unit that stores the compatible function information notified from the another apparatus in response to the request; and
a control unit that controls the communication with the another apparatus on the basis of the compatible function information stored in the storage unit.
   (12)

The data processing apparatus according to (11), further including:
an interface for register communication that exchanges data to be stored or stored in a register of the another apparatus; and
an interface for high-speed communication that performs communication at a higher speed than the register communication for exchanging image data of the image captured by the imaging unit,
in which the compatible function information includes at least one or more pieces of information regarding an authentication scheme with the another apparatus, a functional safety compatible format of the register communication, an encryption scheme of security data of the register communication, an encryption scheme of the register communication, a functional safety compatible format of the high-speed communication, an encryption scheme of security data of the high-speed communication, or an encryption scheme of the high-speed communication.
   (13)

The data processing apparatus according to (11) or (12),
in which in a case where image data captured by the imaging unit is received, an operation state of the another apparatus is checked with reference to the compatible function information added to the image data.
   (14)

The data processing apparatus according to any one of (11) to (13),
the data processing apparatus communicating with a plurality of other apparatuses,
in which in a case where the compatible function information is acquired from each of the plurality of other apparatuses, when there is a function that the other apparatuses do not support and information corresponding to the function is not described, information indicating that the other apparatuses do not support the function is inserted as the information corresponding to the function as processing of unifying formats of the compatible function information.
   (15)

A data processing method in which a data processing apparatus that processes data from another apparatus including an imaging unit that captures an image is configured to:
request the another apparatus to provide notification of compatible function information regarding a supported function as a function when the another apparatus communicates;
store the compatible function information notified from the another apparatus in response to the request; and
control the communication with the another apparatus on the basis of the stored compatible function information.
   (16)

A program for causing a computer that controls a data processing apparatus that processes data from another apparatus including an imaging unit that captures an image to execute processing including steps of:
requesting the another apparatus to notify compatible function information regarding a supported function as a function when the another apparatus performs communication;
storing the compatible function information notified from the another apparatus in response to the request; and
controlling the communication with the another apparatus on the basis of the compatible function information stored.

### REFERENCE SIGNS LIST

1 CIS
2 Host
3 Transmission path
4 Transmission path
110 Communication unit
111 Physical layer
112 Link layer
113 Upper layer
120 Communication unit
123 Data processing unit
124 Sensor unit
130 Register
131 CPU
134 Compatible function calculation unit
210 Communication unit
211 Physical layer
212 Link layer
213 Upper layer
220 Communication unit
223 Data processing unit
230 Register
231 CPU
232 Hardware
311 Sensor register
312 Sensor-compatible function region

1. A data processing apparatus comprising:
an imaging unit that captures an image;
a storage unit that stores compatible function information regarding a supported function as a function when communicating with another apparatus in a read only region; and
an output unit that outputs the compatible function information stored in the storage unit to another apparatus connected.

2. The data processing apparatus according to claim 1,
wherein the storage unit is a register, and a partial region of the register is the read only region.

3. The data processing apparatus according to claim 2, further comprising:
an interface for register communication that exchanges data to be stored or stored in the register with the another apparatus; and
an interface for high-speed communication that performs communication at a higher speed than the register communication for exchanging image data of the image captured by the imaging unit.

4. The data processing apparatus according to claim 3,
wherein the compatible function information includes at least one or more pieces of information regarding an authentication scheme with the another apparatus, a functional safety compatible format of the register communication, an encryption scheme of security data of the register communication, an encryption scheme of the register communication, a functional safety compatible format of the high-speed communication, an encryption scheme of security data of the high-speed communication, or an encryption scheme of the high-speed communication.

5. The data processing apparatus according to claim 1, further comprising
a Fuse,
wherein the compatible function information regarding a selectable function is written in the Fuse.

6. The data processing apparatus according to claim 1, further comprising:
a Fuse; and
a generation unit that generates the compatible function information stored in the storage unit by using information stored in the Fuse.

7. The data processing apparatus according to claim 1,
wherein when image data captured by the imaging unit is output to the another apparatus, part or all of the compatible function information is added to the image data and output.

8. The data processing apparatus according to claim 1,
wherein information is described in the compatible function information on a basis of a predetermined format, and
in a case where there is a function that is not supported, information corresponding to the function is converted into the compatible function information based on the format by inserting information indicating that the function is not supported, and then output to the another apparatus.

9. A data processing method in which a data processing apparatus including an imaging unit that captures an image is configured to:
store compatible function information regarding a supported function as a function when communicating with another apparatus in a read only region; and
output the compatible function information stored to another apparatus connected.

10. A program for causing a computer that controls a data processing apparatus including an imaging unit that captures an image to execute processing including steps of:
storing compatible function information regarding a supported function as a function when communicating with another apparatus in a read only region; and
outputting the compatible function information stored to another apparatus connected.

11. A data processing apparatus comprising:
a request unit that requests another apparatus including an imaging unit that captures an image to notify compatible function information regarding a supported function as a function when the another apparatus performs communication;
a storage unit that stores the compatible function information notified from the another apparatus in response to the request; and
a control unit that controls the communication with the another apparatus on a basis of the compatible function information stored in the storage unit.

12. The data processing apparatus according to claim 11, further comprising:
an interface for register communication that exchanges data to be stored or stored in a register of the another apparatus; and
an interface for high-speed communication that performs communication at a higher speed than the register communication for exchanging image data of the image captured by the imaging unit,
wherein the compatible function information includes at least one or more pieces of information regarding an authentication scheme with the another apparatus, a functional safety compatible format of the register communication, an encryption scheme of security data of the register communication, an encryption scheme of the register communication, a functional safety compatible format of the high-speed communication, an encryption scheme of security data of the high-speed communication, or an encryption scheme of the high-speed communication.

13. The data processing apparatus according to claim 11,
wherein in a case where image data captured by the imaging unit is received, an operation state of the another apparatus is checked with reference to the compatible function information added to the image data.

14. The data processing apparatus according to claim 11,
the data processing apparatus communicating with a plurality of other apparatuses,
wherein in a case where the compatible function information is acquired from each of the plurality of other apparatuses, when there is a function that the other apparatuses do not support and information corresponding to the function is not described, information indicating that the other apparatuses do not support the function is inserted as the information corresponding to the function as processing of unifying formats of the compatible function information.

15. A data processing method in which a data processing apparatus that processes data from another apparatus including an imaging unit that captures an image is configured to:
request the another apparatus to notify compatible function information regarding a supported function as a function when the another apparatus performs communication;
store the compatible function information notified from the another apparatus in response to the request; and
control the communication with the another apparatus on a basis of the compatible function information stored.

16. A program for causing a computer that controls a data processing apparatus that processes data from another apparatus including an imaging unit that captures an image to execute processing including steps of:
requesting the another apparatus to notify compatible function information regarding a supported function as a function when the another apparatus performs communication;
storing the compatible function information notified from the another apparatus in response to the request; and
controlling the communication with the another apparatus on a basis of the compatible function information stored.
